(19) United States
(12) Patent Application Publication
(10) Pub. No.: US 2026/0126786 A1
(43) Pub. Date: May 7, 2026

(54) SYSTEM AND METHOD FOR ARTIFICIAL INTELLIGENCE (AI) BASED ANOMALY DETECTION AND DYNAMIC EVENT THROTTLING

(71) Applicant: Honeywell International Inc., Charlotte, NC (US)

(72) Inventors: Vinothkumar Rajendran, Hosur (IN); Sumathi A, Bangalore (IN); Prasanna S, Bangalore (IN); Akhila S, Bangalore (IN)

(21) Appl. No.: 18/937,048

(22) Filed: Nov. 5, 2024

(51) Int. Cl. G05B 23/02

(52) U.S. Cl. CPC G05B 23/027; G05B 23/0272

(57) ABSTRACT

Various embodiments described herein relate to providing and/or employing a system and a method for tracking incoming events in a facility. In this regard, event data associated with a plurality of events is collected from at least one data source of a plurality of data sources. As a result, duplicate events are identified and filtered out from the plurality of events. Further, a set of anomalous events from the plurality of events is identified after filtering out the duplicate events. In this regard, at least one throttling parameter is adjusted in real-time based on the identification of the set of anomalous events and a current load on the system. Accordingly, processing of critical events from the set of anomalous events is prioritized based on the adjusted at least one throttling parameter.

### TECHNICAL FIELD

The present disclosure is related to managing events within a facility. More particularly, the present disclosure relates to managing high volume event streams in a Security Management System (SMS) in the facility.

### BACKGROUND

In the Security Management System (SMS), multiple subsystems often work together to ensure comprehensive security coverage. These subsystems create a robust and responsive electronic security system, addressing a wide range of security needs from physical access control to network protection and incident management. There could be a variety of subsystems in the Security Management System (SMS) that include, but may not be limited to, CCTV surveillance system, Intrusion Detection System, Access Control System, Fire Alarm System, Building Management System, Video Management System, and/or like. The Security Management System (SMS) is a centralized platform that integrates various security subsystems and provides centralized control for unified management. However, due to the presence of multiple subsystems in the Security Management System (SMS), operators often face challenges when dealing with a high volume of events and/or alarms. Each subsystem may generate its own set of alarms, leading to a flood of notifications that may overwhelm operators. Further, constantly receiving numerous alerts may lead to alert fatigue, where operators may become desensitized and may miss critical alarms. Also, identification and prioritization of important alerts from the sheer volume of notifications may be challenging. Therefore, there is a need to monitor incoming event volumes continuously and efficiently.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments, in which:

FIG. 1 is a schematic diagram illustrating a facility management system managing a plurality of facilities in accordance with one or more embodiments of the present disclosure.

FIG. 2 is a schematic diagram illustrating an exemplary facility of the plurality of facilities in accordance with one or more embodiments of the present disclosure.

FIG. 3 is a schematic diagram illustrating an implementation of a controller of the facility management system that may execute techniques in accordance with one or more embodiments of the present disclosure.

FIG. 4 is an exemplary block diagram illustrating an implementation of a dynamic event throttling system within the Security Management System (SMS) in the facility, in accordance with one or more embodiments of the present disclosure.

FIG. 5 is a flowchart illustrating a method described in accordance with one or more embodiments of the present disclosure.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with an embodiment of the present disclosure, a system for managing events in a facility is described. The system comprises a processor and a memory communicatively coupled to the processor. The memory comprises one or more instructions which when executed by the processor, cause the processor to receive event data associated with a plurality of events from at least one data source of a plurality of data sources, identify duplicate events from the plurality of events within a specific time period from the at least one data source, filter out the duplicate events from the plurality of events based on an analysis of the event data, identify a set of anomalous events from the plurality of events after filtering out the duplicate events, adjust at least one throttling parameter in real-time based on the identification of the set of anomalous events and a current load on the system, and prioritize processing of critical events from the set of anomalous events based on the adjusted at least one throttling parameter.

In accordance with an example embodiment, a method for managing events in a facility is described herein. The method comprises receiving event data associated with a plurality of events from at least one data source of a plurality of data sources, identifying duplicate events from the plurality of events within a specific time period from the at least one data source, filtering out the duplicate events from the plurality of events based on an analysis of the event data, identifying a set of anomalous events from the plurality of events after filtering out the duplicate events, adjusting at least one throttling parameter in real-time based on the identification of the set of anomalous events and a current load on a system, and prioritizing processing of critical events from the set of anomalous events based on the adjusted at least one throttling parameter.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### DETAILED DESCRIPTION

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase may be included in at least one example embodiment of the present disclosure, and may be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some example embodiments, or it may be excluded.

One or more example embodiments of the present disclosure may provide an “Internet-of-Things” or “IoT” platform in a facility that uses real-time accurate models and visual analytics to monitor incoming event volumes in the facility. In addition, the IoT platform provides filtering of duplicate events and/or alarms from single device/point during point state fluctuations and/or transient state fluctuations. The IoT platform is an extensible platform that is portable for deployment in any cloud or data center environment for providing an enterprise-wide, top to bottom view, displaying status of processes, assets, people, and/or safety. Further, the IoT platform of the present disclosure supports end-to-end capability to implement machine learning algorithms into the Security Management System (SMS) for anomaly detection and dynamic event throttling using real-time analytics. Furthermore, event data from multiple events is being used to adjust throttling threshold dynamically, allowing the system to handle varying loads effectively.

In the Security Management System (SMS), multiple subsystems often work together to ensure comprehensive security coverage. These subsystems create a robust and responsive electronic security system, addressing a wide range of security needs from physical access control to network protection and incident management. There could be a variety of subsystems in the Security Management System (SMS) that include, but may not be limited to, CCTV (Closed-Circuit Television) surveillance system, Intrusion Detection System, Access Control System, Fire Alarm System, Building Management System, Video Management System, and/or like. The CCTV surveillance system is designed to monitor and record video footage of various areas within the facility or premises. The Intrusion Detection System is designed to monitor network traffic, detect suspicious activities, and identify potential security breaches or threats within a network or system. The Access Control System is designed to manage and restrict access to physical locations or digital resources within the facility. It ensures that only authorized individuals may enter specific areas or access certain information. The fire alarm system is designed to detect and respond to fire incidents in the facility, ensuring the safety of occupants and protecting property. It detects signs of fire, such as smoke, heat, or flames, and triggers alerts to initiate evacuation and fire response measures. The Building Management System (BMS) integrates various building systems (e.g., HVAC, lighting, access control) into a unified platform. The BMS plays a crucial role in the Security Management System (SMS) by integrating and managing various building operations to ensure efficiency, safety, and security. The Security Management System (SMS) is a centralized platform that integrates various security subsystems and provides centralized control for unified management.

Each subsystem typically includes a variety of devices that work together to fulfill specific functions. In some instances, the access control system includes, but may not be limited to, access control panels, card readers, electric locks, keypads, intercoms, sensors, and/or like. Similarly, the CCTV surveillance subsystem includes, but may not be limited to, cameras, DVRs, NVRs, monitors, video analytic units, cabling and networking equipment, and/or like. Similarly, the fire alarm subsystem includes, but may not be limited to, smoke detectors, heat detectors, fire alarm control panels, and/or like.

In a scenario where thousands of cameras installed in the facility, managing and responding to a high volume of events and/or alarms becomes a significant challenge. There could be a lot of stability issues such as camera network failure, system failure, camera power failure, recording storage issue, and/or like. Additionally, there could be other issues such as, but may not be limited to, sensor malfunctioning, unauthorized access, environmental interference, tampering, network breach, user error, software bugs, and/or like. These issues could trigger thousands of events and/or alarms, and it may cause the system to become non-operational. There are many external factors that influence the stability of the Security Management System (SMS) by creating several individual alarms during Point State (point, device, etc.) fluctuations due to network issues, power issues, storage issues and capability of the external equipment's to manage the environmental condition. When the scale of the point is large, these stability issues put a lot of loads on the system and hence make the system unstable over a period. These unwanted events may compromise the effectiveness of a security system and require regular maintenance, updates, and monitoring to mitigate. It took a lot of effort and time from Project team, Storage team, Network team, and Development team to identify the issues. Accordingly, this inhibits the personnel to take appropriate actions to manage incoming event volumes in the facility. This leads to poor management of events in the facility.

Currently, a primary challenge is continuous flooding of duplicate alarms/events and inadequate throttling in the Security Management System (SMS). Multiple alarms from different systems for the same event or issue may create redundancy and confusion. Continuous flooding of duplicate alarms/events may lead to alarm fatigue, overwhelm operators, inefficient use of resources, and cause potential delays in response. Operators may spend time investigating and resolving duplicate alarms, diverting attention from critical security events. This misallocation of resources may result in slower incident response. Continuously receiving high volume of duplicate alarms may erode trust in the Security Management System (SMS), also it may overload the system and associated tools, leading to performance degradation or even system failures during peak times. If duplicate alarms lead to prolonged incident response times or missed security threats, it can erode trust and confidence in the Security Management System (SMS) among stakeholders, including customers, regulators, and senior management. Further, inadequate throttling in the Security Management System (SMS) may lead to several serious issues that impact both the effectiveness of security operations and the overall performance of the system. Currently, there is no mechanism to implement effective event throttling techniques and filter the duplicate or repeated alarms caused by the point/system state fluctuation in the Security Management System (SMS). Also, it is difficult to manage various subsystems of the Security Management System (SMS) and filter the duplicate events/alarms when the events/alarms are being generated from the various subsystems of Security Management System (SMS) at the same time.

In an instance, in a networked environment where multiple cameras are connected to a network switch, if one camera fails and then restores itself frequently and experiences intermittent failures—going online and offline—it could trigger multiple alarms or alerts. This behavior might be due to network bandwidth issues or internal network problems within the organization. When there is insufficient bandwidth, cameras connected to the network may experience frequent failures and restorations. This may result in repeated disruptions and potential false alarms due to the network's constraints.

Therefore, there is a need to filter unwanted events such as duplicate events and/or alarms from single device/point during point state fluctuations. The single device/point may be a subsystem in the Security Management System (SMS) such as, but may not be limited to, Access control system, Intrusion Detection System, Fire Alarm System, and/or like. The single device/point includes, but may not be limited to, camera, card reader, fire detector, smoke detector, controller, and/or like. In an aspect, the present invention implements a machine learning algorithm that provides filtering of the duplicate events/alarms within a specific time period from the single device/point. This improves overall system reliability and operational efficiency. With advanced machine learning analytics, the present invention helps in detecting and managing event fluctuations, consolidating duplicate events caused by state changes, and ensuring that critical events are prioritized. Also, there is a need to implement a machine learning model for anomaly detection and dynamic event throttling using real-time analytics into the Security Management System (SMS) for efficiently managing high-volume event streams while ensuring important events are not missed. The machine learning model is trained based on historical data. This also improves responsiveness to critical events and fluctuations in event volumes. This also helps in managing high-volume event streams effectively while prioritizing and processing important events in a timely manner. Further, the sensitivity of the system is adjusted based on network conditions or camera performance, this may reduce the likelihood of duplicate alarms. For instance, if a camera frequently goes offline and online, the system may temporarily lower its sensitivity to avoid triggering repeated alerts.

In another aspect of the present invention, dynamic throttling refers to an ability of a system to adjust its processing capacity based on real-time load conditions. This means that the system may scale its resources up or down dynamically, depending on the volume of incoming events from various data sources. In many existing systems, there are predefined limits on the number of events that can be processed within a given time frame. For example, a typical application might be configured to handle a maximum of 10,000 to 20,000 events per minute. When the load exceeds this threshold, say, if 30,000 events are received, the system often struggles to cope. This may lead to performance issues, such as slowdowns or crashes, causing the application to hang or stop functioning entirely. The proposed solution involves implementing dynamic throttling using real-time analytics to adjusts the processing capacity of the system based on real-time conditions. In scenario, when the event load is low, the system may operate efficiently without wasting resources. Conversely, when the load increases beyond the predefined limits, dynamic throttling allows the system to expand its capacity to accommodate the surge in events. Therefore, the system may intelligently assess the incoming event rates and adjust its processing capabilities accordingly. This means that it can effectively “scale up” when needed and “scale down” during quieter periods, maintaining optimal performance at all times. By dynamically adjusting to load conditions, the system minimizes the risk of crashes and maintains operational stability, even during peak event periods. The ability to scale resources based on actual demand helps optimize resource utilization, reducing waste and improving overall system efficiency. The present invention uses event data to adjust throttling thresholds dynamically, allowing the system to handle varying loads effectively. By fine-tuning machine learning algorithms and models based on historical data and feedback loops from operational use, the performance of the system could be optimized and occurrence of false positives/negatives could be reduced.

In yet another aspect of the present invention, the present invention implements an anomaly detection model to identify unusual or outlier events that may indicate point state fluctuations or transient state fluctuations rather than genuine security incidents. To identify unusual or outlier events or any deviations from normal behavior, the statistical methods (like z-score analysis, moving averages), machine learning algorithms (such as isolation forests, one-class SVM), or deep learning models (like autoencoders) could have been utilized. The anomaly detection model may be trained on historical data to learn normal patterns and thresholds. During real-time operation, the events that deviate significantly from these learned patterns could be flagged or marked as potential anomalies.

In yet another aspect of the present invention, the present invention incorporates a fallback mechanism to manage events during throttling periods effectively. For instance, consider a camera that frequently alternates between online and offline states. If the system is set to ignore alarms from this device during a predefined throttling period (e.g., 10 seconds), any alerts triggered within this timeframe will be disregarded. However, if an alarm is generated after the throttling period, it will be accepted by the system. This approach prevents unnecessary clutter in the alarm queue while ensuring that legitimate alerts are still processed once the critical period is ended.

In yet another aspect of the present invention, clustering techniques are applied to enhance event management within the Security Management System (SMS). Clustering involves grouping similar events to identify patterns and reduce noise, effectively acting as a filter for incoming data. Clustering allows categorization of incoming events based on their characteristics, especially during periods of state fluctuations. When multiple similar events occur, clustering groups them together, enabling the system to filter out redundancy. By identifying clusters of events representing the same underlying state, the system may consolidate these into a single representation. This means that instead of processing numerous duplicate events, only unique events proceed for further processing. To further enhance resilience of the Security Management System (SMS) under varying loads, effective queue management is implemented for event processing. The machine learning model is designed to identify and prioritize events based on priority levels—high, medium, and low. This ensures that critical events/alarms are addressed promptly while less urgent alerts are managed accordingly. Once the filtering process is complete, the present invention employs a graceful degradation strategy. This strategy is vital for maintaining essential functionality during high load conditions. By determining which alarms and events are critical to the system's integrity, it is ensured that these alarms are reported to the appropriate personnel. This process refines alarm notifications and prioritizes them based on urgency and relevance.

In yet another aspect of the present invention, continuous collection and evaluation of current metrics such as event arrival rates, processing times, system resource utilization (CPU, memory) against baseline metrics allows to assess the accuracy of the proposed solution. This comprehensive process aims to enhance the reliability and responsiveness of the Security Management System (SMS), ensuring it can effectively manage varying loads and minimize unnecessary alerts.

In yet another aspect of the present invention, a new event classification known as a “transient event classification” is provided that helps in streamlining the events that are brief or temporary in nature, ensuring that they are accurately represented within the system. By marking certain occurrences as “transient events,” redundancy in the processing of the events could be significantly reduced. This classification focuses on events that may appear briefly and could lead to duplicate alerts if not managed properly.

In yet another aspect of the present invention, there is a need to implement a robust real-time data ingestion method that aggregates data from various sources. By processing data from multiple subsystems in real-time, the system may provide immediate alerts and insights, allowing for a quicker response to incidents. Further, aggregating data from various sources provides a more comprehensive view of the security landscape, enabling better decision-making.

In yet another aspect of the present invention, monitoring feedback is crucial for enhancing the effectiveness of the Security Management System (SMS). By continuously tracking the performance of the system and its components, areas for improvement may be identified particularly in reducing duplicate events and alarms. This process ensures that the Security Management System (SMS) remains responsive and efficient in real-world scenarios. A feedback mechanism allows users to report their experiences with the Security Management System (SMS), including any instances of false alarms or duplicate events. This information is vital for refining detection algorithms and improving overall system accuracy. Further, the Security Management System (SMS) may automatically flag repeated events for review.

In yet another aspect of the present invention, a single user interface is provided for managing multiple subsystems in the Security Management System (SMS). This includes, but may not be limited to, events, alarms, subsystem equipment, and/or like. In an embodiment, the user interface may display a real-time analytics dashboard to visualize key metrics such as event arrival rates, processing times, system resource utilization, and/or like. In another embodiment, the real-time analytics dashboard may assist in visualizing at least one of the current load on the system, an event processing rate, and throttling status of the events. The real-time analytics dashboard could be developed using tools like Grafana or Kibana. In another embodiment, the user interface may display status and summary data from various subsystems. In some instances, the user interface provides real-time updates on events such as security breaches, system faults, or environmental changes. The user interface allows operators to monitor the key metrics using line charts, bar charts, and/or like to understand the current system load and performance. Further, the user interface allows operators to view detailed logs, investigate incidents, and take one or more corrective actions. The user interface provides one or more insights into system performance, security incidents, and usage patterns.

In yet another aspect of the present invention, a machine leaning model is implemented to predict future event rates and adjust throttling thresholds proactively. Further, techniques such as time series forecasting, or anomaly detection could have been used to predict spikes or drops in event volumes.

Therefore, various examples of systems and methods described herein relate to managing events in the facility. In this regard, various example embodiments described herein facilitate a dynamic event throttling system used to manage incoming high-volume event streams in the facility based on various techniques and prioritize processing of critical events in a timely manner. Per this aspect, the systems and methods described herein receive event data associated with the events in real-time from multiple data sources. The event data may include detailed information related to events. The event data includes, but may not be limited to, timestamp associated with the event (i.e. date and time when the event occurred), type of the event (login attempt, file access, system change, and/or like), severity level of the event, time duration of occurrence of the event, geolocation of the event, unique identifier associated with the event, source of the event, and/or like. The events may be associated with at least one of unauthorized access, false alarm, environmental interference, network breach, tampering, system failure, user errors, software bugs, and sensor malfunction. These unwanted events may compromise the effectiveness of the SMS and require regular maintenance, updates, and monitoring to mitigate. Further, various example embodiments described herein identify duplicate events within a specific time period from at least one data source. Further, various example embodiments described herein filter out the duplicate events based on an analysis of the event data. Further, various example embodiments described herein identify a set of anomalous events after filtering out the duplicate events. Further, various example embodiments described herein adjust at least one throttling parameter in real-time based on the identification of the set of anomalous events and a current load on the system. Further, various example embodiments described herein prioritize processing of critical events from the set of anomalous events based on the adjusted at least one throttling parameter. Further, various example embodiments described herein generate, on a user interface of at least one display device, a visualization dashboard that displays at least one of the key metrics, the current load on the system, an event processing rate, and throttling status of the events.

Further, various example embodiments described herein translate the key metrics and other parameters such as the current load on the system, an event processing rate, and throttling status of the events to understandable insights and recommendations. In one example, the insights may be related to system performance insights and/or operational insights. In yet another example, the insights may be throttling insights such as analyzing how current throttling settings affect the event processing rate and system performance. In yet another example, the insights may be opportunities or corrective actions for managing the incoming event volumes in the facility. The insights may be in the form of reports, trends, charts, graphs, and/or like. The aforementioned exemplary insights facilitate the systems and methods described herein to undertake relevant actions so as to efficiently manage the incoming event volumes in the facility.

In addition, the systems and methods described herein also render the insights on a display. For example, the display may be of a mobile device associated with personnel in the facility. The systems and methods described herein translate the key metrics and other parameters such as the current load on the system, an event processing rate, and throttling status of the events to understandable insights so that the personnel even with minimal domain knowledge may understand and relate context of the insights. This facilitates the user to make appropriate decisions and undertake relevant actions to manage the incoming event volumes in the facility. In some situations, the personnel may also apply their domain knowledge to additionally provide feedback on the insights rendered on the display so that the relevancy of insights may be improved.

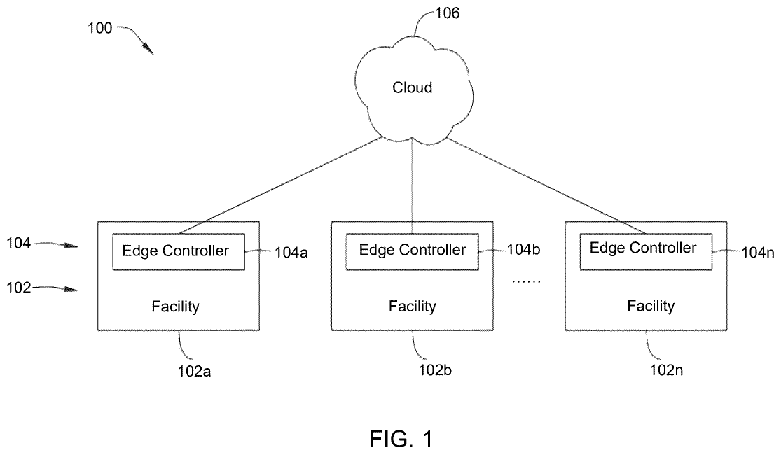

FIG. 1 illustrates a schematic diagram showing a facility management system to manage multiple facilities in accordance with one or more example embodiments described herein. According to various example embodiments described herein, the exemplary facility management system 100 comprises one or more facilities 102a, 102b, . . . 102n (collectively “facilities 102”). In this regard, a facility of the one or more facilities 102a, 102b, . . . 102n may correspond to, for example, a corporate office, a business facility, a government building, an educational institution, a financial institution, a data center, a healthcare facility, a retail store, a shopping mall, an industrial plant, a production plant, a manufacturing unit, a refinery, a factory, an industry, a logistics environment, a transportation hub, a material handling environment, a warehouse, a distribution center, a sortation center, a supply chain environment, a pharmaceutical unit, a residential complex, a high-end apartment, and/or the like. In some example embodiments, the one or more facilities 102a, 102b, . . . 102n in the illustrative system 100 may be of same type. In some example embodiments, the one or more facilities 102a, 102b, . . . 102n in the illustrative system 100 may be of different type. As it may be understood, in some example embodiments described herein, in the Security Management System (SMS), each of the facilities 102 often include one or more assets. The “one or more assets” refer to the various physical and logical components that are managed, monitored, and protected to ensure the security and the operational efficiency of the facility. Physical assets include surveillance equipment such as cameras, digital video recorders, network video recorders, and/or like; access control systems such as biometric scanners, card readers, keypads, and/or like; alarm systems such as intrusion alarms, fire alarms, environmental sensors, and/or like; perimeter security such as fencing, barriers, gates, bollards, and/or like; and emergency response equipment such as panic buttons, public address systems, and/or like. Generally, the one or more assets are operated to handle one or more processes in the facility. For example, CCTV cameras may be used for real-time video monitoring and recording, environmental sensors may be used for detecting gas leaks, water leaks, or other environmental hazards, sensors and alarms may be used for detecting unauthorized entry, and or like.

Further, in one or more example embodiments described herein, each of the one or more facilities 102a, 102b, . . . 102n includes a respective edge controller 104a, 104b, . . . 104n (collectively “edge controllers 104”). Per this aspect, the edge controller of the respective facility collects data associated with the one or more assets in the facility. In accordance with some example embodiments, one or more sensors are employed in the facility to sense the data associated with the one or more assets. In accordance with some example embodiments, the one or more sensors is communicatively coupled with the edge controller of the facility. Accordingly, the edge controller of the facility receives the data associated with the one or more assets via the one or more sensors. In addition, in some example embodiments, the edge controllers 104 process the data received from the one or more sensors to derive insights associated with each of the one or more assets. In this regard, the insights may be related to security events, and/or the like associated with each of the one or more assets. Also, in some example embodiments, the edge controllers 104 may undertake one or more corrective actions to handle fluctuations in incoming event volumes within the facility.

Further, in some example embodiments, the one or more facilities 102a, 102b, . . . 102n may be operably coupled with a cloud 106, meaning that communication between the cloud 106 and the one or more facilities 102a, 102b, . . . 102n is enabled. In some example embodiments, the one or more edge controllers 104a, 104b, . . . 104n may be communicatively coupled to the cloud 106. The cloud 106 may represent distributed computing resources, software, platform or infrastructure services which may enable data handling, data processing, data management, and/or analytical operations on the data exchanged & transacted amongst the facilities 102. In accordance with some example embodiments, the data collected by the edge controllers 104 is uploaded to the cloud 106 for processing. Further, in accordance with some example embodiments, the cloud 106 processes event data associated with each of the one or more assets. In this regard, the cloud 106 also derives the insights associated with the event data, and/or the like. Also, in some example embodiments, the cloud 106 may generate one or more opportunities and/or corrective actions based on the derived insights. Additionally, in some example embodiments, the cloud 106 may transmit the one or more opportunities and/or corrective actions to a respective edge controller of the one or more edge controllers 104a, 104b, . . . 104n in the facility. Also, in some example embodiments, the cloud 106 may transmit the insights, the one or more opportunities, and/or corrective actions to a mobile device associated with the personnel in the facility.

In some example embodiments, the one or more edge controllers 104a, 104b, . . . 104n may operate as intermediary node to transact data between a respective facility and/or the cloud 106. In some example embodiments, each of the one or more edge controllers 104a, 104b, . . . 104n is capable of processing and/or filtering the collected data so as to be compatible with the cloud 106. In some example embodiments, each of the one or more facilities 102a, 102b, . . . 102n may comprise a respective gateway to transact data between a respective facility and/or the cloud 106. Accordingly, in some example embodiments, gateway may operate as intermediary node to transact data between a respective facility and/or the cloud 106. In some example embodiments, the cloud 106 includes one or more servers that may be programmed to communicate with the one or more facilities 102a, 102b, . . . 102n and to exchange data as appropriate. The cloud 106 may be a single computer server or may include a plurality of computer servers. In some example embodiments, the cloud 106 may represent a hierarchal arrangement of two or more computer servers, where perhaps a lower level computer server (or servers) processes telemetry data, for example, while a higher-level computer server oversees operation of the lower level computer server or servers.

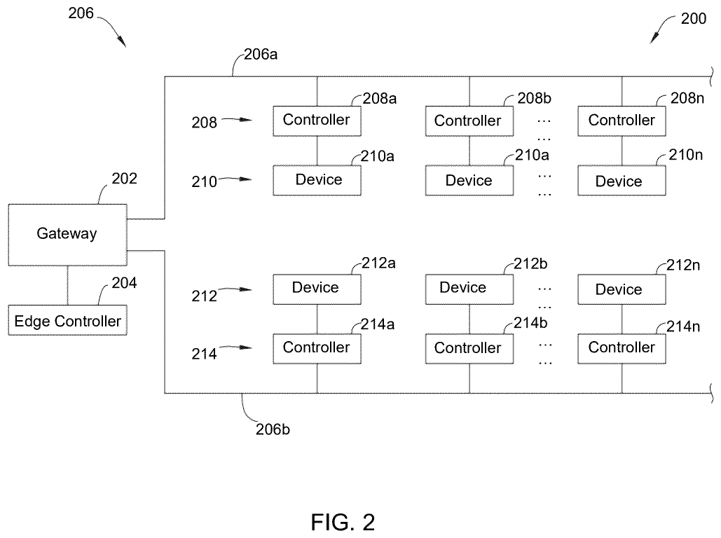

FIG. 2 illustrates a schematic diagram showing an exemplary facility in accordance with one or more example embodiments described herein. In one or more example embodiments, an example facility 200 described herein corresponds to one of the facilities 102 described in accordance with FIG. 1 of the current disclosure. In various example embodiments, the example facility 200 of FIG. 2 comprises assets communicatively coupled via multiple networks 206 (e.g., communication channels). For instance, as illustrated in FIG. 2, the facility 200 includes a first network 206a and a second network 206b. In some example embodiments, the facility 200 may include only a single network 206. In some example embodiments, the facility 200 may include multiple networks 206. Each of the networks 206 may include any available network infrastructure. In some example embodiments, each of the networks 206 may independently be, for example, a BACnet network, a NIAGARA network, a NIAGARA CLOUD network, or others. Accordingly, in some example embodiments, the facility 200 comprises a plurality of assets and/or devices in communication with a gateway 202 via corresponding communication channel (e.g., networks 206a and/or 206b). Said differently, each of the network represents a sub-network supported by an underlined network communication/IoT protocol and incorporating a cluster of endpoints (e.g. assets, controllers etc. in building facility).

In some example embodiments, one or more first assets 210a, 210b, . . . 210n (collectively “first assets 210”) are operably coupled to the first network 206a via one or more first controllers 208a, 208b, . . . 208n (collectively “first controllers 208”). In some other example embodiments, the first controllers 208 are operably coupled to one or more sensors associated with different types of the first assets 210 within the facility 200. The first assets 210 represent different types of data sources that are present within the facility 200. The data sources may include, but may not be limited to, surveillance camera, access control system, alarm system, HVAC system, lighting control system, emergency communication system, fire and safety equipment, and/or like. In some example embodiments, at least some of the first assets 210 include, but may not be limited to surveillance equipment such as cameras, digital video recorders, network video recorders, and/or like; access control systems such as biometric scanners, card readers, keypads, and/or like; alarm systems such as intrusion alarms, fire alarms, environmental sensors, and/or like; perimeter security such as fencing, barriers, gates, bollards, and/or like; and emergency response equipment such as panic buttons, public address systems, and/or like. In this regard, the one or more sensors may correspond to cameras, access control sensors, environmental sensors, smoke detectors, intrusion sensors, and/or the like. Per this aspect, the one or more sensors associated with the first assets 210 may detect a variety of security events and conditions that could indicate potential threats. The security events include, but may not be limited to, unauthorized access, environmental hazards, physical security breaches, system failures, emergency situations, and/or anomalies. These security events are critical for initiating responses, mitigating risks, and ensuring overall security and integrity of the facility. Further, in some example embodiments, the one or more sensors transmit the event data to the first controllers 208.

In some example embodiments, the first controllers 208 control operation of at least one of the first assets 210. In this regard, the first controllers 208 process and/or analyze the event data to derive one or more insights for at least some of the first assets 210 in the facility 200. In this regard, the insights may be related to the event data, and/or the like associated with at least some of the first assets 210. Also, in some example embodiments, the first controllers 208 may undertake one or more corrective actions to handle fluctuations in incoming event volumes based on the derived insights within the facility 200. In accordance with some example embodiments, the first controllers 208 may be built into one or more of the corresponding first assets 210 and need not be a separate component. Whereas, in accordance with some other example embodiments, the first controllers 208 may be virtual controllers that may be implemented within a virtual environment hosted by one or more computing devices (not illustrated). In another example embodiment, at least some of the first assets 210 may be controllers. In such case, the first assets 210 need not have a separate corresponding controller of the first controllers 208.

In some example embodiments, one or more second assets 212a, 212b, . . . 212n (collectively “second assets 212”), are operably coupled to the second network 206b via one or more second controllers 214a, 214b, . . . 214n (collectively “second controllers 214”). In some other example embodiments, the second controllers 214 are operably coupled to one or more sensors associated with different types of the second assets 212 within the facility 200. The second assets 212 represent different types of data sources that are present within the facility 200. The data sources may include, but not limited to, surveillance camera, access control system, alarm system, HVAC system, lighting control system, emergency communication system, fire and safety equipment, and/or like. In some example embodiments, at least some of the second assets 212 are, but not limited to surveillance equipment such as cameras, digital video recorders, network video recorders, and/or like; access control systems such as biometric scanners, card readers, keypads, and/or like; alarm systems such as intrusion alarms, fire alarms, environmental sensors, and/or like; perimeter security such as fencing, barriers, gates, bollards, and/or like; and emergency response equipment such as panic buttons, public address systems, and/or like. In this regard, the one or more sensors may correspond to cameras, access control sensors, environmental sensors, smoke detectors, intrusion sensors, and/or the like. Per this aspect, the one or more sensors associated with the second assets 212 detect a variety of security events and conditions that could indicate potential threats. The security events include, but may not be limited to, unauthorized access, environmental hazards, physical security breaches, system failures, emergency situations, and/or anomalies. These security events are critical for initiating responses, mitigating risks, and ensuring overall security and integrity of the facility. Further, in some example embodiments, the one or more sensors transmit the event data to the second controllers 214.

In some example embodiments, the second controllers 214 control operation of at least one of the second assets 212. In this regard, the second controllers 214 process and/or analyze the event data to derive one or more insights for at least some of the second assets 212 in the facility 200. In this regard, the insights may be related to the event data, and/or the like associated with at least some of the second assets 212. Also, in some example embodiments, the second controllers 214 may undertake one or more corrective actions to handle fluctuations in incoming event volumes based on the derived insights within the facility 200. In accordance with some example embodiments, the second controllers 214 may be built into one or more of the corresponding second assets 212 and need not be a separate component. Whereas, in accordance with some other example embodiments, the second controllers 214 may be virtual controllers that may be implemented within a virtual environment hosted by one or more computing devices (not illustrated). In another example embodiment, at least some of the second assets 212 may be controllers. In such case, the second assets 212 need not have a separate corresponding controller of the second controllers 214.

Further, in some example embodiments, the facility 200 includes a gateway 202 that is operably coupled with the first network 206a and the second network 206b. In one example embodiment, the gateway 202 may be operably coupled with the first network 206a but not with the second network 206b. In another example embodiment, the gateway 202 may be operably coupled with the second network 206b but not with the first network 206a. Accordingly, in some example embodiments, the gateway 202 is a legacy controller. In some example embodiments, the gateway 202 may be absent. In accordance with some example embodiments, an edge controller 204 is installed within the facility 200. In some example embodiments, the edge controller 204 may be operably coupled with the gateway 202. In this regard, the edge controller 204 serves as an intermediary node between the first controllers 208, the second controllers 214, and the cloud 106 (as described in accordance with FIG. 1 of the current disclosure). For instance, in an example, the edge controller 204 may pull data from the first controllers 208 and the second controllers 214 and provide the data to the cloud 106. In an example embodiment, the edge controller 204 is configured to discover the first assets 210, the second assets 212, the first controllers 208, and/or the second controllers 214 that are connected along a local network such as the network 206. In an example embodiment, the network protocol of the network 206 includes discovery commands that, for example, are used to request that all assets connected to the network 206 identify themselves. Whereas, in another example, the edge controller 204 is configured to discover the first assets 210 and the second assets 212 regardless of an underlaying protocol supported by the first assets 210 and the second assets 212. In other words, the edge controller 204 may discover the first assets 210 and the second assets 212 supported by different protocols (e.g., BACnet, Modbus, LonWorks, SNMP, MQTT, Foxs, OPC UA etc.).

Further, in some example embodiments, the edge controller 204 interrogates any assets it finds operably coupled to the network 206 to obtain additional information from those assets that further helps the edge controller 204 and/or the cloud 106 identify the connected assets, functionality of the assets, connectivity of the local controllers and/or the assets, types of operational data that is available from the local controllers and/or the assets, types of alarms that are available from the local controllers and/or the assets, and/or any other suitable information.

More generally, and in some example embodiments, the edge controller 204 is communicatively coupled to one or more assets, via one or more networks. For purpose of brevity, the term ‘assets’ is also referred interchangeably to as ‘data points’, ‘end points’, ‘devices’, ‘sensors’, or ‘electronic devices’ throughout the description. According to various example embodiments described herein, the assets include, for example, but not limited to, sensors, electronic components, pressure valves, HVACs, alarm units, building management systems, building controllers, industrial subsystems, industrial controllers, lightning systems, air detective systems, air quality sensors, etc. These may correspond to, for example, one or more of the first assets 210 and the second assets 212.

According to an example embodiment, the edge controller 204 is configured to receive the event data from the one or more assets (i.e. data sources) corresponding to various independent and diverse sub-systems in the facility 200 (e.g., but may not be limited to, a building, an industrial plant, a warehouse, a factory, etc.). The one or more assets correspond to various independent and diverse sub-systems in the facility 200. In some examples, the event data may represent time-series data and may include a plurality of data values associated with the assets which may be collected over a period of time. For instance, in an example, the event data may represent a plurality of sensor readings collected by a sensor over a period of time. The event data may be indicative of ancillary or contextual information associated with the one or more events. For instance, in an example, the event data may include access control data, surveillance data, alarm data, environmental data, incident data, system data. One or more parameters corresponding to the event data include time stamp indicating exact time of the occurrence of the event, location information indicating location of the occurrence of the event, criticality of the event, nature of the event, and/or like.

In accordance with an example embodiment, the edge controller 204 is configured to discover and identify the one or more assets which are communicatively coupled to the edge controller 204. Further, upon identification of the assets, the example edge controller 204 is configured to pull the event data from the various identified assets. In an example, these assets may correspond to one or more electronic devices that may be located on-premises in the facility 200. The edge controller 204 is configured to pull the data by sending one or more data interrogation requests to the one or more assets. These data interrogation requests may be based on a protocol supported by an underlying one or more assets.

In accordance with an example embodiment, the edge controller 204 is configured to receive the event data in various data formats or different data structures. In an example, a format of the event data received at the edge controller 204 may be in accordance with a communication protocol of the network supporting transaction of data amongst two or more network nodes (i.e., the edge controller 204 and the asset). As may be appreciated, in some example embodiments, the various assets in the facility 200 may be supported by one or more of various network protocols (e.g., IOT protocols like BACnet, Modbus, LonWorks, SNMP, MQTT, Foxs, OPC UA etc.). Accordingly, and in some cases, the edge controller 204 is configured to pull the event data in accordance with communication protocol supported by the one or more assets.

In some example embodiments, the edge controller 204 is configured to process the received data and transform the data into a unified data format. The unified data format is referred hereinafter as a common object model. In an example, the common object model is in accordance with an object model that may be required by one or more data analytics applications or services, supported at the cloud 106. In some example embodiments, the edge controller 204 may perform data normalization to normalize the received data into a pre-defined data format. In an example, the pre-defined format may represent a common object model in which the edge controller 204 may further push the event data to the cloud 106. In some example embodiments, the edge controller 204 is configured to establish a secure communication channel with the cloud 106. In this regard, the data may be transacted between the edge controller 204 and the cloud 106, via the secure communication channel. In some example embodiments, the edge controller 204 may send the data to the cloud 106 automatically at pre-defined time intervals. In some example embodiments, at least a part of the data may correspond to historic data. In some example embodiments, the edge controller 204 and/or the cloud 106 may derive the one or more insights associated in the facility 200 based on the common object model as well.

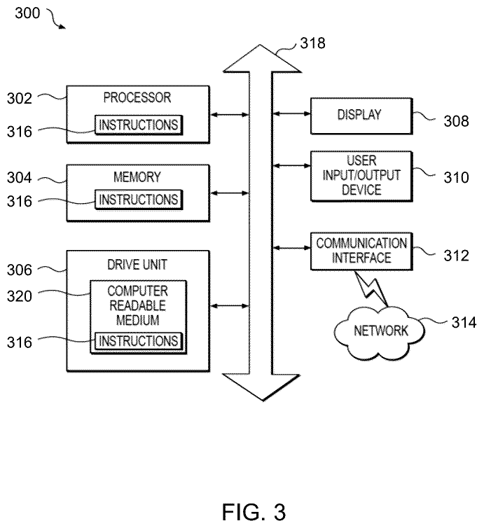

FIG. 3 illustrates a schematic diagram showing an implementation of a controller that may execute techniques in accordance with one or more example embodiments described herein. The controller 300 may include a set of instructions that may be executed to cause the controller 300 to perform any one or more of the methods or computer-based functions disclosed herein. The controller 300 may operate as a standalone device or may be connected, e.g., using a network, to other computer systems or peripheral devices.

In a networked deployment, the controller 300 may operate in the capacity of a server or as a client in a server-client user network environment, or as a peer computer system in a peer-to-peer (or distributed) network environment. The controller 300 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 300 may be implemented using electronic devices that provide voice, video, or data communication. Further, while the controller 300 is illustrated as a single system, the term “system” shall also be taken to include any collection of systems or sub-systems that individually or jointly execute a set, or multiple sets, of instructions to perform one or more computer functions.

As illustrated in FIG. 3, the controller 300 may include a processor 302, e.g., a central processing unit (CPU), a graphics processing unit (GPU), or both. The processor 302 may be a component in a variety of systems. For example, the processor 302 may be part of a standard computer. The processor 302 may be one or more general processors, digital signal processors, application specific integrated circuits, field programmable gate arrays, servers, networks, digital circuits, analog circuits, combinations thereof, or other now known or later developed devices for analyzing and processing data. The processor 302 may implement a software program, such as code generated manually (i.e., programmed).

The controller 300 may include a memory 304 that may communicate via a bus 318. The memory 304 may be a main memory, a static memory, or a dynamic memory. The memory 304 includes, but may not be limited to, computer readable storage media such as various types of volatile and non-volatile storage media, including but may not be limited to, random access memory, read-only memory, programmable read-only memory, electrically programmable read-only memory, electrically erasable read-only memory, flash memory, magnetic tape or disk, optical media and the like. In one implementation, the memory 304 includes a cache or random-access memory for the processor 302. In alternative implementations, the memory 304 is separate from the processor 302, such as a cache memory of the processor 302, the system memory, or other memory. The memory 304 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 304 is operable to store instructions executable by the processor 302. The functions, acts or tasks illustrated in the figures or described herein may be performed by the processor 302 executing the instructions stored in the memory 304. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 300 may further include a display 308, such as a liquid crystal display (LCD), an organic light emitting diode (OLED), a flat panel display, a solid-state display, a cathode ray tube (CRT), a projector, a printer or other now known or later developed display device for outputting determined information. The display 308 may act as an interface for the user to see the functioning of the processor 302, or specifically as an interface with the software stored in the memory 304 or in the drive unit 306.

Additionally or alternatively, the controller 300 may include an input/output device 310 configured to allow a user to interact with any of the components of controller 300. The input/output device 310 may be a number pad, a keyboard, or a cursor control device, such as a mouse, or a joystick, touch screen display, remote control, or any other device operative to interact with the controller 300.

The controller 300 may also or alternatively include drive unit 306 implemented as a disk or optical drive. The drive unit 306 may include a computer-readable medium 320 in which one or more sets of instructions 316, e.g. software, may be embedded. Further, the instructions 316 may embody one or more of the methods or logic as described herein. The instructions 316 may reside completely or partially within the memory 304 and/or within the processor 302 during execution by the controller 300. The memory 304 and the processor 302 also may include computer-readable media as discussed above.

In some systems, a computer-readable medium 320 includes instructions 316 or receives and executes instructions 316 responsive to a propagated signal so that a device connected to a network 314 may communicate voice, video, audio, images, or any other data over the network 314. Further, the instructions 316 may be transmitted or received over the network 314 via a communication port or interface 312, and/or using a bus 318. The communication port or interface 312 may be a part of the processor 302 or may be a separate component. The communication port or interface 312 may be created in software or may be a physical connection in hardware. The communication port or interface 312 may be configured to connect with a network 314, external media, the display 308, or any other components in controller 300, or combinations thereof. The connection with the network 314 may be a physical connection, such as a wired Ethernet connection or may be established wirelessly as discussed below. Likewise, the additional connections with other components of the controller 300 may be physical connections or may be established wirelessly. The network 314 may alternatively be directly connected to a bus 318.

While the computer-readable medium 320 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 320 may be non-transitory, and may be tangible.

The computer-readable medium 320 may include a solid-state memory such as a memory card or other package that houses one or more non-volatile read-only memories. The computer-readable medium 320 may be a random-access memory or other volatile re-writable memory. Additionally or alternatively, the computer-readable medium 320 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, may be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

The controller 300 may be connected to a network 314. The network 314 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but may not be limited to, TCP/IP based networking protocols. The network 314 may include wide area networks (WAN), such as the Internet, local area networks (LAN), campus area networks, metropolitan area networks, a direct connection such as through a Universal Serial Bus (USB) port, or any other networks that may allow for data communication. The network 314 may be configured to couple one computing device to another computing device to enable communication of data between the devices. The network 314 may generally be enabled to employ any form of machine-readable media for communicating information from one device to another. The network 314 may include communication methods by which information may travel between computing devices. The network 314 may be divided into sub-networks. The sub-networks may allow access to all of the other components connected thereto or the sub-networks may restrict access between the components. The network 314 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations may include distributed processing, component/object distributed processing, and parallel processing. Alternatively, virtual computer system processing may be constructed to implement one or more of the methods or functionalities as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

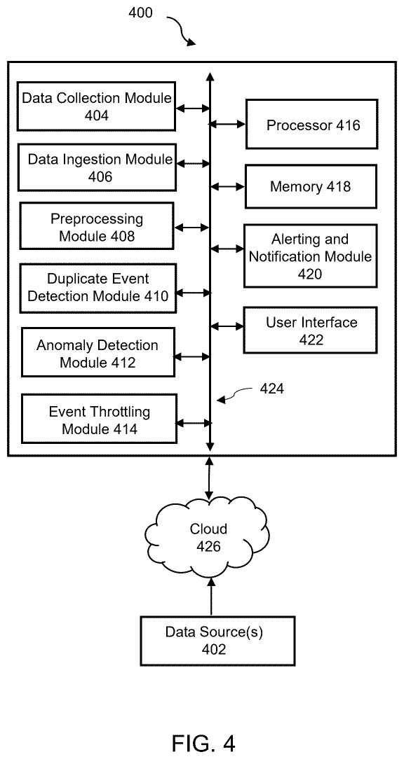

FIG. 4 is an exemplary block diagram illustrating an implementation of a dynamic event throttling system 400 in the facility, in accordance with one or more embodiments of the present disclosure. In accordance with one or more example embodiments, the dynamic event throttling system 400 described herein manages multiple incoming events in the facility. In accordance with one or more example embodiments, the dynamic event throttling system 400 described herein tracks incoming event volumes in real-time in the facility to prevent overload and ensure efficient processing. In accordance with one or more example embodiments, the dynamic event throttling system 400 described herein implements mechanisms to filter out duplicate events and/or alarms from a single source during point state fluctuations and/or transient state fluctuations. In accordance with one or more example embodiments, the dynamic event throttling system 400 described herein implements advanced machine learning algorithms to identify unusual patterns (i.e. unusual spikes or drops) in the event data, helping to detect potential security incidents or system issues. In accordance with one or more example embodiments, the dynamic event throttling system 400 described herein adjusts event processing rates based on real-time analytics, allowing for responsive handling of fluctuating event volumes. In this regard, the dynamic event throttling system 400 collects and aggregates event data associated with the incoming events continuously in real-time from a plurality of data sources. The event data may include detailed information related to the event such as timestamp associated with the event (i.e. date and time when the event occurred), type of the event (login attempt, file access, system change, and/or like), severity level of the event, time duration of occurrence of the event, geolocation of the event, unique identifier associated with the event, source of the event, and/or like. The dynamic event throttling system 400 utilizes advanced machine learning algorithms to analyze incoming event patterns and system load, allowing for intelligent decision-making regarding event processing rates. The dynamic event throttling system 400 implements rules that identify and prioritize critical events (e.g., security breaches, malware infections) for immediate processing while temporarily delays the processing of less critical events during high-load situations. The dynamic event throttling system 400 offer several valuable insights corresponding to the security operations and system performance metrics in the facility. For example, the dynamic event throttling system 400 analyzes historical data to identify trends in event volume during specific periods (e.g., daily, weekly, seasonal), aiding in resource allocation. Whereas in another example, the dynamic event throttling system 400 monitors resource utilization during varying event processing rates to optimize resource allocation. Further, by identifying any critical events that may have been delayed or missed due to throttling, the dynamic event throttling system 400 refines rules or machine learning algorithms as necessary. Accordingly, the dynamic event throttling system 400 facilitates a practical application of managing flooding of events in an effective manner. Further, it supports in efficiently utilizing system resources by scaling event processing according to real-time demands, reducing unnecessary strain on the infrastructure. Further, the use of machine learning allows to adapt to changing event patterns and system conditions, improving over time based on historical data. Further, the dynamic event throttling system 400 incorporates a fallback mechanism to manage critical events during throttling periods effectively. Thus, the dynamic event throttling system 400 assists in managing incoming event volumes effectively.

In an example embodiment the dynamic event throttling system 400 is a server system (e.g., a server device) that facilitates a data analytics platform between one or more computing devices, one or more data sources, and/or one or more assets. In one or more example embodiments, the dynamic event throttling system 400 is a device with one or more processors and a memory. Also, in some example embodiments, the dynamic event throttling system 400 is implementable via the cloud 106. The dynamic event throttling system 400 is implementable in one or more facilities related to one or more technologies, for example, but not limited to, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies.

In some example embodiments, the dynamic event throttling system 400 comprises one or more components and/or sub-systems such as data source(s) 402, a data collection module 404, a data ingestion module 406, a preprocessing module 408, a duplicate event detection module 410, an anomaly detection module 412, an event throttling module 414, an alerting and notification module 420, and/or a user interface 422. Additionally, in one or more example embodiments, the dynamic event throttling system 400 comprises a processor 416 and/or memory 418. In one or more example embodiments, one or more components and/or sub-systems of the dynamic event throttling system 400 may be communicatively coupled to the processor 416 and/or the memory 418 via a bus 424. In certain example embodiments, one or more aspects of the dynamic event throttling system 400 (and/or other systems, apparatuses and/or processes disclosed herein) constitute executable instructions embodied within a computer-readable storage medium (e.g., the memory 418). For instance, in an example embodiment, the memory 418 stores computer executable component and/or executable instructions (e.g., program instructions). Furthermore, the processor 416 facilitates execution of the computer executable components and/or the executable instructions (e.g., the program instructions). In an example embodiment, the processor 416 is configured to execute instructions stored in memory 418 or otherwise accessible to the processor 416.

The processor 416 is a hardware entity (e.g., physically embodied in circuitry) capable of performing operations according to one or more embodiments of the disclosure. Alternatively, in an example embodiment where the processor 416 is embodied as an executor of software instructions, the software instructions configure the processor 416 to perform one or more algorithms and/or operations described herein in response to the software instructions being executed. In an example embodiment, the processor 416 is a single core processor, a multi-core processor, multiple processors internal to the dynamic event throttling system 400, a remote processor (e.g., a processor implemented on a server), and/or a virtual machine. In certain example embodiments, the processor 416 is in communication with the memory 418, the data source(s) 402, the data collection module 404, the data ingestion module 406, the preprocessing module 408, the duplicate event detection module 410, the anomaly detection module 412, the event throttling module 414, the alerting and notification module 420, and/or the user interface 422 via the bus 424 to, for example, facilitate transmission of data between the processor 416, the memory 418, the data source(s) 402, the data collection module 404, the data ingestion module 406, the preprocessing module 408, the duplicate event detection module 410, the anomaly detection module 412, the event throttling module 414, the alerting and notification module 420, and/or the user interface 422. In some example embodiments, the processor 416 may be embodied in a number of different ways and, in certain example embodiments, includes one or more processing devices configured to perform independently. Additionally or alternatively, in one or more example embodiments, the processor 416 includes one or more processors configured in tandem via bus 424 to enable independent execution of instructions, pipelining of data, and/or multi-thread execution of instructions.

The memory 418 is non-transitory and includes, for example, one or more volatile memories and/or one or more non-volatile memories. In other words, in one or more example embodiments, the memory 418 is an electronic storage device (e.g., a computer-readable storage medium). The memory 418 is configured to store information, data, content, one or more applications, one or more instructions, or the like, to enable the dynamic event throttling system 400 to carry out various functions in accordance with one or more embodiments disclosed herein. In accordance with some example embodiments described herein, the memory 418 may correspond to an internal or external memory of the dynamic event throttling system 400. In some examples, the memory 418 may correspond to a database communicatively coupled to the dynamic event throttling system 400. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

In one or more embodiments, the data source(s) 402 may represent different types of sources responsible for generation of events within the facility. In one or more example embodiments, the data source(s) 402 may include, but not limited to, system logs, application logs, sensors, security devices, monitoring tools, databases, and/or like. In some example embodiments, at least some of the security devices are, but not limited to surveillance camera, access control system, alarm system, HVAC system, lighting control system, emergency communication system, fire and safety equipment, and/or like. The system logs and/or application logs provide information about system activities, user actions, and potential security incidents. Sensor data received form the sensors could be related to system performance data, physical security data, access control events, and/or like. The one or more sensors may correspond to cameras, temperature sensors, pressure sensors, heat sensors, humidity sensors, motion sensors, and/or the like. Alerts and logs from security-specific devices such as firewalls, intrusion detection systems (IDS), and security cameras provide information on detected threats, blocked access attempts, video surveillance events, and/or like. Monitoring data from the monitoring tools provide information about user actions and interactions with systems and applications. This could be related to login attempts, access patterns, changes to user permissions, and/or like.

In one or more embodiments, the data collection module 404 may continuously collect and aggregate event data associated with the events in real-time from the data source(s) 402. The data collection module 404 is crucial in tracking the volume of incoming events. In an instance, the events could be security events. In one or more example embodiments, the security events include, but may not be limited to, unauthorized access, sensor malfunction, false alarms, environmental interference, system failure, tampering, security alerts, system performance metrics, data breach, phishing attack, ransomware attacks, Denial of Service (DoS) attacks, insider threats, malware infections, network breach, user errors, software bugs, and/or like. In one example, the false alarms may occur when the system is triggered by non-threatening events, such as pets, weather conditions, or system malfunctions. Issues with sensors may cause them to fail to detect intrusions or to trigger false alarms. In another example, unauthorized access may occur when someone gains access to a secure area without proper authorization, either through hacking, stolen credentials, or physical breaches. In yet another example, environmental interference factors such as heavy rain, fog, or dust may affect the performance of cameras and sensors. These unwanted events may compromise the effectiveness of the SMS and require regular maintenance, updates, and monitoring to mitigate. The data collection module 404 includes mechanisms for obtaining the real-time event data associated with the events from the data source(s) 402. The real-time event data includes, but may not be limited to, timestamp associated with the event (i.e. date and time when the event occurred), type of the event (login attempt, file access, system change, and/or like), severity level of the event, time duration of occurrence of the event, geolocation of the event, unique identifier associated with the event, source of the event, and/or like.

In one or more embodiments, the data ingestion module 406 plays a crucial role in collecting, aggregating, and storing real-time event data, which is used for filtering out duplicate events and/or alarms during fluctuations. The data ingestion module 406 of the dynamic event throttling system 400 handles integration of event data from various data source(s) 402 into the system. It ensures that incoming security events and data are captured in real-time and prepared for further processing. The data ingestion module 406 uses data pipelines and streaming technologies for real-time data ingestion. This ensures compatibility with various data source(s) 402 and smooth integration into the dynamic event throttling system 400. This also involves configuring data transfer protocols and ensuring compatibility between the data collection module 404 and the data ingestion module 406. The data ingestion module 406 includes a time-series database that can efficiently handle large volumes of event data.

In one or more embodiments, the preprocessing module 408 performs data cleaning to remove or correct erroneous or incomplete data and subsequently performs data normalization on the incoming event data to ensure consistency and reliability of unique events for further analysis.

In one or more embodiments, the duplicate event detection module 410 may identify duplicate alarms or events during point state fluctuations and/or transient state fluctuations. The duplicate event detection module 410 defines a time window during which alarms are considered part of the same transient state. When multiple alarms occur within the defined window, these multiple alarms may be related to the same event. Further, the duplicate event detection module 410 uses pattern recognition techniques to identify transient state patterns such as spikes in network traffic or system load indicative of event flooding and consolidate duplicates caused by the same due to state fluctuations. The duplicate event detection module 410 identifies sudden spikes or abnormal patterns in event frequency using statistical analysis. Also, the duplicate event detection module 410 sets threshold to filter out alarms that are part of the transient state. Alarms that exceed the set threshold within a specified timeframe are flagged as potential duplicates. The duplicate event detection module 410 uses historical data to set baselines for normal behavior and filter out fluctuations that fall within expected ranges. The duplicate event detection module 410 integrates AI-based anomaly detection and event clustering methods into the SMS to apply clustering to incoming sensor data and events to identify clusters representing the same state fluctuation in real time. By consolidating these events into a single representation or record, duplicate registrations and alarms may be prevented. Additionally, the duplicate event detection module 410 assesses the reduction in duplicate events and false alarms compared to baseline performance metrics and measure the accuracy of anomaly detection and the effectiveness of event clustering in preventing duplicates. The disclosed system implements monitoring mechanisms to track the effectiveness of the AI methods in reducing duplicate events and alarms. Further, feedback mechanisms are incorporated to continuously improve the models based on real-world performance. This ensures that only unique events proceed for further analysis.

In one or more embodiments, the anomaly detection module 412 may include one or more anomaly detection models. The one or more anomaly detection models identify patterns in the event data that do not conform to expected behavior, which may indicate potential issues or unusual events. These models play a crucial role in detecting unusual activity that might signify security threats, operational issues, or other critical anomalies. The anomaly detection models are trained based on the historical data to learn normal patterns and thresholds. The anomaly detection module 412 collects historical data from various data source(s) 402. During real-time operation, the incoming events that deviate significantly from these learned patterns and thresholds are flagged as potential anomalies. The anomaly detection module 412 implements anomaly detection algorithms to identify unusual or outlier events that may indicate transient state fluctuations or point state fluctuations rather than genuine security incidents in real-time. The transient state fluctuations are temporary changes or deviations in system behavior or data that are not indicative of a lasting issue or a security threat but may trigger unnecessary alerts. The transient state fluctuations are usually short-lived and often revert to normal once the temporary condition is resolved. For example, a temporary spike in network traffic due to scheduled maintenance or updates, false alarms, device malfunctions, environmental interference, brief fluctuations in temperature readings due to air conditioning system adjustments, and/or like. However, genuine security incidents are events or conditions that indicate a real and potentially harmful security threat or breach. The genuine security incidents often require immediate attention and action to mitigate potential damage or prevent further issues. The anomaly detection module 412 uses advanced statistical methods (such as z-score analysis, moving averages), machine learning algorithms (such as isolation forests, one-class Support Vector Machine (SVM)), and deep learning models (such as autoencoders) to detect deviations from normal behavior. This would significantly enhance anomaly detection.

In one or more embodiments, the event throttling module 414 utilizes advanced machine learning algorithms for dynamic throttling within the SMS environment. The event throttling module 414 utilizes an automated throttling mechanism that dynamically controls or adjusts the rate of event processing based on real-time analytics insights. The event throttling module 414 may adjust the event processing rate by automatically scaling up or scaling down the rate of event processing based on event volume and system load. This helps in handling fluctuations in incoming event volumes. During peak periods or when an unexpected surge in event rates occurs (e.g., during a cyber-attack), the event throttling module 414 may allocate additional resources (e.g., spin up more processing instances, increase memory allocation) to ensure that event processing remains efficient. Conversely, during quieter periods, the event throttling module 414 may release unnecessary resources to save costs and prevent overprovisioning. The event throttling module 414 may employ dynamic throttling threshold, allowing it to regulate the flow of incoming events based on current processing capacity. The throttling threshold is a predefined limit that indicates the maximum number of events or requests that the SMS may handle within a specified time frame. It serves as a control mechanism to manage and regulate the flow of incoming events to prevent system overload and maintain optimal performance. The throttling threshold can be adjusted dynamically based on real-time assessments of system load, historical event patterns, and predictive models. When the throttling threshold is exceeded, the event throttling module 414 may implement measures such as delaying processing, dropping less critical events, or providing users with feedback about current load conditions. In this regard, the event throttling module 414 implements rules to prioritize processing of critical events to ensure that critical events are processed immediately, even during high load periods while temporarily delaying non-critical ones. Further, the event throttling module 414 manages event queues effectively, ensuring that the disclosed system remains responsive and resilient under varying loads. By leveraging real-time analytics to automate event flooding detection and throttling, organizations may achieve a more resilient and responsive system that adapts dynamically to changing operational conditions while maintaining high standards of performance and reliability. The event flooding is detected when the number of events exceeds a threshold value. Further, the event throttling module 414 modifies or adjusts throttling parameters such as thresholds, event processing rates, and a resource allocation limit based on real-time analytics and system load. The event throttling module 414 defines strategies for graceful degradation such as critical path identification, fallback mechanism, load shedding to maintain essential functionalities even under high load conditions. The strategies for graceful degradation may be applied when number of incoming events or the number of anomalous events exceeds a predetermined threshold. The critical path identification enables identification of critical paths and functionalities that must be prioritized to maintain system integrity. The fallback mechanisms or alternative processing paths is utilized for handling or prioritizing critical events during throttling periods. The load shedding implements controlled event rejection or delay mechanisms for non-critical events to prevent system overload. The event throttling module 414 processes the filtered events for further processing.

The alerting and notification module 420 provides notifications and alerts to operators and/or administrators about system conditions and potential issues. Further, the alerting and notification module 420 notifies operators when predefined thresholds relating to incoming event rates are exceeded. The alerting and notification module 420 provides throttling alerts about automatic throttling actions taken by the dynamic event throttling system 400 to manage the system load. These throttling alerts inform administrators about the actions taken by the dynamic event throttling system 400, allowing them to understand the context of the load conditions and any potential impact on user experience. The alerting and notification module 420 continuously monitors system performance metrics and event rates, ensuring that any changes are detected promptly. This enables timely responses to issues before they escalate.

Further, in some example embodiments, the one or more insights may be transmitted to the user interface 422. Per this aspect, the one or more insights may be rendered on the user interface 422. In one or more embodiments, the user interface 422 is configured to display the one or more insights. The one or more insights may be presented in the form reports, dashboard, descriptions, charts, trends, graphs, and/or like. This may include bar charts, pie charts, or line graphs. In one or more example embodiments, the one or more insights include, but may not be limited to, current system load, event processing rates, and throttling status, and/or like. In one or more example embodiments, the one or more insights could be related to key performance metrics. The key performance metrics is monitored to determine current system load and performance.

Further, in some example embodiments, the dynamic event throttling system 400 may utilize the machine learning algorithm to provide the one or more insights based on the key performance metric and one or more parameters such as the current system load, the event processing rates, the throttling status of the one or more events, and/or like. Said alternatively, the machine learning algorithm comprises one or more models that can be used by the dynamic event throttling system 400 to provide the one or more insights. Also, in some example embodiments, the machine learning algorithm may be trained with one or more datasets to facilitate provision of the one or more insights. In this regard, the one or more datasets may be related to the historical data. Additionally, in some example embodiments, the one or more insights may be provided as feedback. Whereas in some example embodiments, the personnel in the facility may also provide feedback on the one or more insights or input actions undertaken by them. In this regard, the machine learning algorithm may learn over time to provide improved and accurate insights. For example, the dynamic event throttling system 400 may flag one or more actions taken by the personnel in the facility if they are determined to have caused a spike in incoming event volumes in the facility. In another example, the dynamic event throttling system 400 may generate new insights based on one or more actions taken by personnel in the facility. Also, in some example embodiments, the machine learning algorithm may be trained with one or more new datasets on a regular basis or for a pre-defined time interval to improve relevancy of insights.

The present invention implements mechanisms for continuous improvement based on user feedback and the key performance metrics such as analyzing the historical data and user feedback to optimize throttling algorithms and parameters. The system is configured to track system performance and provide insights corresponding to handling of events effectively.

In one or more example embodiments, one or more actions may be rendered on the user interface 422. In one example, one or more actions may include predicting future event rates and adjusting throttling thresholds proactively. In another example, the one or more root causes related to the incoming event volumes may be rendered on the user interface 422. One or more root causes may include camera network failures, camera power failures, recording network storage issues, and/or like. The user interface 422 may correspond to an interface of a device associated with personnel in the facility. In one example, the user interface 422 may correspond to an interface of a device associated with an operator or the personnel in the facility. In another example, the user interface 422 may correspond to an interface of a device associated with a supervisor of the operator in the facility. In some example embodiments, one or more alert signals may be generated based on the one or more insights. In some example embodiments, the one or more alert signals may be transmitted to the user interface 422. In this regard, in some example embodiments, one or more notifications may be generated on the user interface 422 based on the one or more alert signals. Accordingly, in some examples, the one or more notifications may be visual notifications. Whereas, in some examples, the one or more notifications may be audio notifications. Also, in some example embodiments, the user interface 422 may allow the personnel to provide input and/or feedback regarding the one or more insights. For example, an input may correspond an operator selecting a corrective action. In this regard, the one or more insights may be rendered as visualizations, such as on the user interface 422, to help the personnel such as field operators to identify the one or more insights and thereby undertake appropriate actions.

In some example embodiments, the one or more components, one or more sub-systems, processor 416 and/or memory 418 of the dynamic event throttling system 400 may be communicatively coupled to cloud 426 over a network. In this regard, the one or more components, processor 416 and/or memory 418 along with the cloud 426 manage incoming event volumes in the facility. In some example embodiments, the network may be for example, a Wi-Fi network, a Near Field Communications (NFC) network, a Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, a BACnet network, a NIAGARA network, a NIAGARA CLOUD network, and/or another type of network. In some example embodiments, the event data received from the data source(s) 402 may be transmitted to the cloud 426. In some example embodiments, the cloud 426 may be configured to perform one or more operations/functionalities of the one or more components, one or more sub-systems, processor 416 and/or memory 418 of the dynamic event throttling system 400.

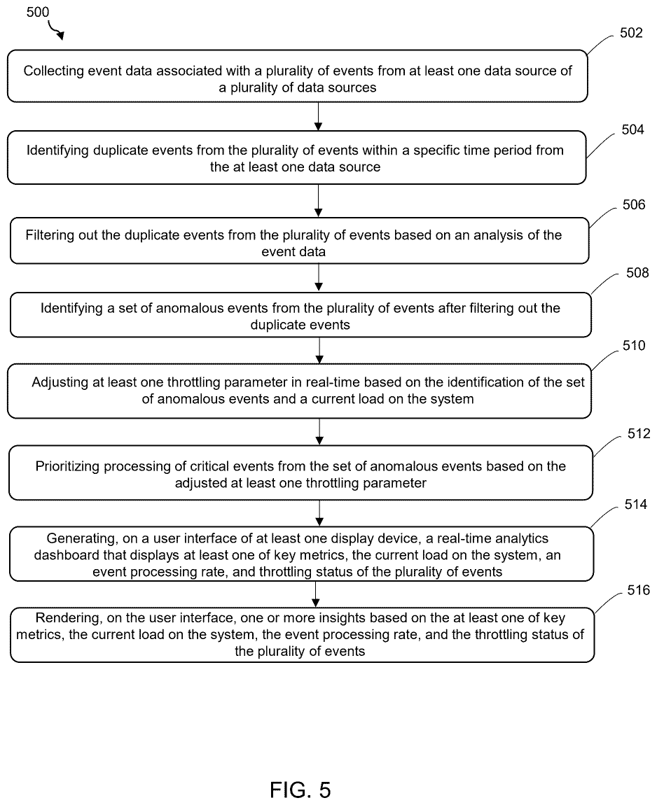

FIG. 5 is a flowchart illustrating example operations of managing a plurality of events associated with a plurality of data sources in the facility, in accordance with one or more embodiments of the present disclosure. An exemplary flowchart 500 describes an exemplary method for managing the plurality of events in the facility via the dynamic event throttling system 400. At step 502, the dynamic event throttling system 400 includes means, such as the data collection module 404 to collect event data associated with a plurality of events from at least one data source of a plurality of data sources 402 in real-time. At step 504, the dynamic event throttling system 400 includes means, such as the duplicate event detection module 410 to identify duplicate events from the plurality of events within a specific time period from the at least one data source. Further, at step 506, the duplicate event detection module 410 filters out the duplicate events from the plurality of events based on an analysis of the event data. Further, at step 508, the dynamic event throttling system 400 includes means, such as the anomaly detection module 412 to identify a set of anomalous events from the plurality of events after filtering out the duplicate events. At step 510, the dynamic event throttling system 400 includes means, such as the event throttling module 414 to adjust at least one throttling parameter in real-time based on the identification of the set of anomalous events and a current load on the system. Further, at step 512, the event throttling module 414 prioritizes processing of critical events from the set of anomalous events based on the adjusted at least one throttling parameter. At step 514, the dynamic event throttling system 400 includes means, such as the user interface 422 to generate a real-time analytics dashboard that displays at least one of key metrics, the current load on the system, an event processing rate, and throttling status of the plurality of events. Further, at step 516, the user interface 422 renders one or more insights based on the at least one of key metrics, the current load on the system, the event processing rate, and the throttling status of the plurality of events.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

1. A system, comprising:
a processor; and
a memory communicatively coupled to the processor, wherein the memory comprises one or more instructions which when executed by the processor, cause the processor to:
receive event data associated with a plurality of events from at least one data source of a plurality of data sources;
identify duplicate events from the plurality of events within a specific time period from the at least one data source;
filter out the duplicate events from the plurality of events based on an analysis of the event data;
identify a set of anomalous events from the plurality of events after filtering out the duplicate events;
adjust at least one throttling parameter in real-time based on the identification of the set of anomalous events and a current load on the system; and
prioritize processing of critical events from the set of anomalous events based on the adjusted at least one throttling parameter.

2. The system of claim 1, wherein the processor is further configured to apply clustering to the duplicate events from the at least one data source during one of point state fluctuations or transient state fluctuations.

3. The system of claim 1, wherein the processor is further configured to identify event flooding when a number of the plurality of events exceeds a threshold value.

4. The system of claim 1, wherein the at least one throttling parameter includes at least one of a throttling threshold, an event processing rate, and a resource allocation limit.

5. The system of claim 1, wherein the adjustment of the at least one throttling parameter comprises one of scale up or scale down an event processing rate of the set of anomalous events.

6. The system of claim 1, wherein the processor is further configured to implement a controlled event rejection process for non-critical events when a number of the set of anomalous events is above a predetermined threshold and the current load on the system is high.

7. The system of claim 3, wherein the processor is further configured to generate an alert notification based on the identification of the event flooding.

8. The system of claim 1, wherein the processor is further configured to generate, on a user interface of at least one display device, a real-time analytics dashboard that displays at least one of key metrics, the current load on the system, an event processing rate, and throttling status of the plurality of events.

9. The system of claim 1, wherein the plurality of events is associated with at least one of unauthorized access, false alarm, environmental interference, network breach, tampering, system failure, and sensor malfunction.

10. The system of claim 1, wherein the set of anomalous events are identified based on one or more anomaly detection algorithms.

11. A method, comprising:
receiving event data associated with a plurality of events from at least one data source of a plurality of data sources;
identifying duplicate events from the plurality of events within a specific time period from the at least one data source;
filtering out the duplicate events from the plurality of events based on an analysis of the event data;
identifying a set of anomalous events from the plurality of events after filtering out the duplicate events;
adjusting at least one throttling parameter in real-time based on the identification of the set of anomalous events and a current load on a system; and
prioritizing processing of critical events from the set of anomalous events based on the adjusted at least one throttling parameter.

12. The method of claim 11, further comprising applying clustering to the duplicate events from the at least one data source during one of point state fluctuations or transient state fluctuations.

13. The method of claim 11, further comprising identifying event flooding when a number of the plurality of events exceeds a threshold value.

14. The method of claim 11, wherein the at least one throttling parameter includes at least one of a throttling threshold, an event processing rate, and a resource allocation limit.

15. The method of claim 11, wherein the adjustment of the at least one throttling parameter comprises one of scale up or scale down an event processing rate of the set of anomalous events.

16. The method of claim 11, further comprising implementing a controlled event rejection process for non-critical events when a number of the set of anomalous events is above a predetermined threshold and the current load on the system is high.

17. The method of claim 13, further comprising generating an alert notification based on the identification of the event flooding.

18. The method of claim 11, further comprising generating, on a user interface of at least one display device, a real-time analytics dashboard that displays at least one of key metrics, the current load on the system, an event processing rate, and throttling status of the plurality of events.

19. The method of claim 11, wherein the set of anomalous events are identified based on one or more anomaly detection algorithms.

20. A non-transitory computer-readable medium having instructions stored thereon that, when executed by at least one processor of a system, cause the at least one processor to perform operations comprising:
receiving event data associated with a plurality of events from at least one data source of a plurality of data sources;
identifying duplicate events from the plurality of events within a specific time period from the at least one data source;
filtering out the duplicate events from the plurality of events based on an analysis of the event data;
identifying a set of anomalous events from the plurality of events after filtering out the duplicate events;
adjusting at least one throttling parameter in real-time based on the identification of the set of anomalous events and a current load on the system; and
prioritizing processing of critical events from the set of anomalous events based on the adjusted at least one throttling parameter.
